(19) United States
(12) Patent Application Publication
(10) Pub. No.: US 2019/0097275 A1
(43) Pub. Date: Mar. 28, 2019

(54) SELENIUM IMPREGNATED MATERIALS AS FREE-STANDING ELECTRODES

(71) Applicant: David Mitlin, (US)

(72) Inventors: David Mitlin, Hannawa Falls, NY (US); Jia Ding, Edmonton AB (CA)

(73) Assignee: David Mitlin, Hannawa Falls, NY (US)

(21) Appl. No.: 16/139,426

(22) Filed: Sep. 24, 2018

Related U.S. Application Data
(60) Provisional application No. 62/563,453, filed on Sep. 26, 2017.

(51) Int. Cl. H01M 10/42; H01M 4/62

(52) U.S. Cl. CPC H01M 10/4235; H01M 4/628

(57) ABSTRACT

A material used as an electrode or an additive in an electrochemical storage device, the material including a carbon material; and a compound selected from the group consisting of Se, SeySx, TeySx, TezSeySx and combinations thereof, where x, y and z are any value between 0 and 1, the sum of y and x being 1, and the sum of z, y and x being 1, the compound impregnated in the carbon material. An electrode including the aforementioned material and a method to improve performance of an electrochemical storage device, the method including incorporating the aforementioned material into the electrochemical storage device.

### CROSS REFERENCE TO RELATED APPLICATIONS

The instant application is a non-provisional application claiming priority to co-pending U.S. Provisional Patent Application No. 62/563,453, filed on Sep. 26, 2017, which is hereby incorporated by reference in its entirety.

### FIELD OF INVENTION

The present invention relates to free-standing electrodes, and more particularly, relates to selenium (Se) based electrode materials that are monolithic and free-standing.

### BACKGROUND

Energy density (energy per volume) is an important consideration for portable, automotive and stationary battery applications. While lithium batteries (lithium ion batteries, commonly referred to as “LIBs”) are a ubiquitous commercial technology, sodium batteries (sodium ion batteries, commonly referred to as “NIBs” and “SIBs”) and potassium batteries (potassium ion batteries, sometimes referred to as “KIBs”) are receiving increasing scientific attention due to the much wider distributed reserves of sodium (Na) and potassium (K) precursors and the cost savings associated with an aluminum versus a copper anode current collector. Currently, LIBs and SIBs are dominant. The next generation of batteries are referred to as metal batteries, and are based on a metal anode due to its higher capacity and cell energy. Such metal batteries are termed lithium metal batteries (referred to as “LMBs”) and sodium metal batteries (referred to as “SMBs”).

In LIBs and SIBs, the gravimetric capacity of the cathode is lower than that of the anode. On a volumetric basis, however, it is the graphite anode in the LIBs and the hard carbon anode in the SIBs that takes up the most room in a cell. Therefore, the general effort for LIBs and SIBs technologies is to advance high capacity cathodes and simultaneously metal anodes. For instance, lithium rich and nickel rich layered oxides as cathodes, and other emerging cathodes, are being explored. For these systems, some challenges, such as the oxygen loss, high 1^{st} cycle capacity loss and voltage decay have not been resolved.

Group 16 element based cathodes, e.g. Li—O₂, Li—S batteries, have the potential to provide 2-5 times capacity of the conventional ceramic cathodes. However, both the Li—O₂ and Li—S systems suffer from poor cyclability and other unresolved problems. In the case of sodium, the Na—O₂ and Na—S systems are early in their development and there is documented low reactivity between solid sulfur and sodium at room temperature.

Selenium (Se) possesses similar chemical and electrochemical properties to sulfur, but orders of magnitude higher electrical conductivity. Selenium with an equilibrium trigonal structure has an electrical conductivity on the order of 10⁻³ S m⁻¹, while amorphous Se has a conductivity on the order of 10⁻¹¹ S m⁻¹. Selenium is a reasonably priced element, and when reacted with Li or Na, selenium has only a slightly lower energy density as compared with sulfur. It has been recently demonstrated that selenium electrochemically reacts with both Li and Na in standard carbonate based electrolytes.

To date, studies on selenium as lithium and sodium battery cathodes are relatively limited and a broader side-by-side investigation of the electrochemical behavior of Se with Li versus Na would be desirable. Despite the heavy focus on specific capacity (energy per weight) in scientific literature, it is the energy density (energy per volume) that is the primary consideration for most portable, stationary and even automotive applications. It is desired to develop new materials for use as electrodes in lithium and sodium batteries (LIBs, LMBs, SIBs, SMBs) to achieve higher energy both by weight and by volume.

### SUMMARY

Accordingly, it is an object of the present invention to provide a material for use as an electrode for batteries, the material including selenium. It is a further object of the present invention to provide a material for electrodes, the material including selenium and sulfur. It is a further object to provide a battery or electrochemical capacitor storage device including such materials as electrodes.

It is a further object of the present invention to provide an electrode that achieves a dense, low surface area monolithic microstructure. It is a further object of the present invention to provide electrodes with high storage capacity. It is another object of the invention to provide a material including a carbon material that possesses an exceptionally high mass loading of selenium, which can be used as a free-standing electrode in a battery and improves the battery's capacity and energy (per volume, per weight), rate capability and cycling stability. It is another object of this invention to provide more effective material as an electrode than a conventional powdered electrode and to minimize parasitic reactions with the electrolyte at high anodic/cathodic voltages, thereby improving the Coulombic efficiency (CE) and reducing solid electrolyte interphase (SEI) growth and cathode electrolyte interphase (CEI) growth.

A particular embodiment is directed to material used as an electrode or an additive in an electrochemical storage device, the material including: a carbon material; and a compound selected from the group consisting of Se, SeySx, TeySx, TezSeySx and combinations thereof, where x, y and x are any value between 0 and 1, the sum of y and x being 1, and the sum of z, y and x being 1, the compound impregnated in the carbon material.

In one embodiment of the material, the compound is present in an amount of 9-90% by weight, based on the total weight of the material. In another embodiment of the material, the electrochemical storage device is selected from the group consisting of an ion battery and a metal battery, wherein a charge transfer ion in the electrochemical storage device is selected from the group consisting of lithium ion, calcium ion, sodium ion, potassium ion, hydrogen ion, magnesium ion, ClO4—, PF6—, and a combination thereof.

In one embodiment, the material is: substantially free of open pores, monolithic, or free-standing, or a combination of any of the foregoing. The carbon material in the material includes at least one of a plant-based material, a fossil-fuel based material, a research-grade polymer material, an organic solution material, an organic waste product material, a biological tissue material, a metal-organic framework material, and a carbon-containing synthetic material. The plant-based material is selected from the group consisting of hemp-based material, cannabis-based material, wood-based material, ramie-based material, jute-based material, flax-based material, kenaf-based material, and combinations thereof.

In one embodiment of the material, the carbon material includes at least one of a doped carbon material and an un-doped carbon material, wherein the doped carbon material comprises at least one of a nitrogen, phosphorus, sulfur and an oxygen atom, the dopant having an atomic content of about 0.75 weight % to about 75 weight % based on the total weight of the carbon material.

Another particular embodiment is directed to a method to improve performance of an electrochemical storage device. The method includes incorporating the aforementioned material into an electrochemical storage device, wherein the material is incorporated into at least one of: an electrode, a separator and an electrolyte, thereby improving at least one of: cycling stability, Coulombic efficiency (CE), solid electrolyte interphase growth (SEI), and dendrite growth.

A further embodiment is directed to an electrochemical storage device that includes a housing; and at least one electrode comprising a compound selected from the group consisting of Se, SeySx, TeySx, TezSeySx and combinations thereof, where x, y and z are any value between 0 and 1, the sum of y and x being 1, and the sum of x, y and z being 1.

In one embodiment of the electrochemical storage device, the at least one electrode is a negative electrode, the negative electrode further including a lithium source or a sodium source. In one embodiment of the device, the at least one electrode is a negative electrode, the negative electrode further including a graphite anode, a hard carbon anode, a tin anode, a Ge anode, or a titania anode.

In another embodiment of the device, the at least one electrode is a positive electrode, the positive electrode further comprising a carbon material. In one embodiment of the device, the at least one electrode is a positive electrode, the positive electrode further including a lithium iron phosphate (LFP) cathode, a nickel cobalt aluminum (NCA) cathode, a nickel manganese cobalt (NMC) cathode, or a lithium cobalt oxide (LCO) cathode.

The electrochemical storage device in one embodiment further includes a second electrode, the second electrode being an negative electrode selected from the group consisting of an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, and a nitride anode.

The electrochemical storage device further includes at least one of carbonate containing electrolyte and polymer separator.

The housing of the electrochemical storage device includes a form of a D-cell sized battery, a pouch cell, a rectangular automotive starter battery scale cell, a C-cell sized battery, an AA-cell sized battery, an AAA-cell sized battery, an 18650 lithium ion battery, or a 26650 lithium ion battery.

In one embodiment of the electrochemical storage device the at least one electrode is a cathode, and the electrochemical storage device further comprises a second electrode, the second electrode is an anode selected from the group consisting of an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, and a nitride anode.

The electrochemical storage device discussed herein can be an electrochemical capacitor, primary or secondary battery, a flow battery, a hybrid ion capacitor or a supercapattery.

A further embodiment of the invention is a battery including an anode; a separator; a cathode, the cathode comprising: a carbon material and at least one compound selected from the group consisting of Se, SeySx, TeySx, TezSeySx, and combinations thereof, wherein the at least one compound is impregnated into the carbon-material; and an electrolyte.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a schematic representation of a material according to one embodiment of the present invention.

FIGS. 2A and 2B Each illustrate an electrochemical storage device according to one embodiment of the present invention

FIGS. 3A, 3B, 3C and 3D are scanning electron microscope (SEM) images of a material according to one embodiment of the present invention.

FIGS. 4A, 4B, 4C and 4D are graphs illustrating results of tests used to investigate the selenium to carbon weight ratio in a material according to one embodiment of the present invention. In particular, FIG. 4A is a thermogravimetric analysis (TGA) for Se-NCMC samples. FIG. 4B is x-ray diffraction (XRD) patterns of selenium power, melted selenium and Se-NCMC specimens. FIG. 4C is raman spectra of selenium power and Se-NCMC specimens. FIG. 4D is high resolution XPS spectra of C 1s and Se 3d for NCMC and Se-NCMC specimens. FIG. 4E is nitrogen adsorption-desorption isotherms of NCMC and Se-NCMC specimens. FIG. 4F is corresponding pore size distributions, as calculated by density functional theory (DFT).

FIGS. 5A, 5B, 5C, 5D, 5E, 5F and 5G are graphs illustrating aspects of electrochemical performance of a material according to one embodiment of the present invention. In particular, FIG. 5A is cyclic voltammograms (CVs) at scan rate of 0.1 mV s⁻¹. FIG. 5B is galvanostatic discharge/charge profiles, tested at 135 mAg⁻¹ (0.2 C). FIG. 5C is energy densities as a function of voltage at 135 mAg⁻¹. FIG. 5D is rate performance of Se-NCMC. FIG. 5E is changes in the shape of discharge/charge profiles of Se-NCMC cathodes at different C rate. FIG. 5F is a comparison of the gravimetric and volumetric energy density between Se-NCMC and the commercialized cathode materials. FIG. 5G is cyclability of Se-NCMC at 135 mAg⁻¹ (0.2 C).

FIGS. 6A, 6B, 6C, 6D and 6E are graphs illustrating aspects of electrochemical performance of a material according to one embodiment of the present invention. In particular, FIG. 6A is cyclic voltammograms (CVs) at scan rate of 0.1 mV s⁻¹. FIG. 6B is galvanostatic discharge/charge profiles, tested at 67.5 mAg⁻¹ (0.1 C). FIG. 6C is energy densities as a function of voltage at 135 mAg⁻¹. FIG. 6D is rate performance of Se-NCMC. FIG. 6E is cyclability of Se-NCMC at 135 mAg⁻¹ (0.2 C).

FIGS. 7A, 7B, 7C, 7D, 7E and 7F are graphs illustrating aspects of electrochemical kinetics of a material according to one embodiment of the present invention. In particular, FIG. 7A and FIG. 7B are multi-rate CV curves vs. Li/Li⁺ and Na/Na⁺, respectively. FIG. 7C is the overpotential values of the lithium and sodium systems at various scan rates. FIG. 7D is b-value determination based on logarithmic peak currents versus scan rate. FIG. 7E is the variation of normalized capacity as a function of the inverse square root of the scan rate. FIG. 7F is a comparison of capacity retention as a function of current density, for lithium and sodium systems.

FIGS. 8A and 8B are graphs illustrating the first cycle charge/discharge profiles of Se-NCMC in lithium (Li) cells (FIG. 8(a)) and sodium (Na) cells (FIG. 8(b)).

FIGS. 9A and 9B are graphs illustrating the first cycle galvanostatic charge/discharge profiles or amorphous selenium (Se), test as lithium (Li) and sodium (Na) cells.

FIGS. 10A, 10B, 10C, 10D are scanning electron microscope (SEM) images and corresponding EDX Se maps of the Se-NCMC electrode.

### DETAILED DESCRIPTION

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

The present invention relates to electrodes for electrochemical storage devices (also referred to as energy storage devices or electrochemical energy storage devices) and more specifically to materials used as electrodes. In particular, the present invention relates to materials having certain compounds therein, the materials being substantially pore free, monolithic, or free-standing (or any combination of substantially pore free, monolithic, and free-standing) and electrochemical storage devices incorporating the same. The invention is applicable to primary and secondary batteries and particularly lithium and sodium batteries. The present invention also relates to selenium impregnated electrodes with a selenium loading of 70%. The present invention also relates to selenium impregnated electrodes further including other Group 16 elements such as sulfur and tellurium.

### Material for Use as an Electrode or Additive in an Electrochemical Storage Device

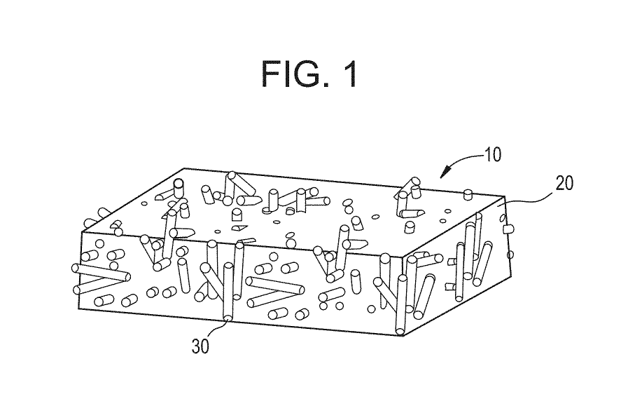

FIG. 1 illustrates a material 10 used as an electrode or an additive in an electrochemical storage device. The term “electrode” encompasses any electrode used in an electrochemical storage device, including negative electrodes and positive electrodes. Negative electrodes are referred to as anodes in batteries, while positive electrodes are referred to as cathodes in batteries. It is contemplated that the material 10 as described herein can be used as a negative electrode or a positive electrode. The term “additive” as used herein means an electrolyte and/or a separator.

The material 10 can be used as an electrode or additive in any type of electrochemical storage device, including, but not limited to, an electrochemical capacitor, a primary battery, a secondary battery, a flow battery, a hybrid ion capacitor or a supercapattery. In one embodiment, the material 10 is used as an electrode or additive in a primary or secondary battery. In particular, the material is used as an electrode in an ion battery or a metal battery. A charge ion in the primary or secondary battery is a lithium ion, a calcium ion, a sodium ion, a potassium ion, a hydrogen ion, a magnesium ion, ClO4—, PF6—, or a combination thereof.

The material 10 includes a carbon material 20 and a compound 30 impregnated in the carbon material 20. The term “impregnated” means the presence of the compound 30 in the carbon material 20, and includes, e.g., the carbon material 20 encompassing the compound 30, permeation of the carbon material 30 by the compound, assembly of the compound 30 into the carbon material 20, and any type of bonding of the compound 30 to the carbon material 20.

In one embodiment, the carbon material 20 includes any type of natural or synthetic material that contains any amount of carbon. For example, the carbon material 20 is at least one of a plant-based material, a fossil-fuel based material, a research-grade polymer material, an organic solution material, an organic waste product material, a biological tissue material, a metal-organic framework material, and a carbon-containing synthetic material.

Plant-based materials useful to obtain the carbon material 20 include, but are not limited to cellulosic-based materials. For example, plant based materials useful to obtain the carbon material 20 include hemp-based material, cannabis-based material, wood-based material, ramie-based material, jute-based material, flax-based material, kenaf-based material, and combinations thereof. Additional examples of plant based materials useful to obtain the carbon material 20 include cellulose-lignin composites, a nanocellulose-derived porous carbon film, plant hurd, sawdust, soy hulls, rice hulls, wheat straw, and the like. For example, a renewable tree-derived nanocrystalline cellulose (NCC) is used. In other embodiments one or a combination of lignin, starch, crude fiber, hemicellulose, sugar, ash, amorphous cellulose, and pectin is used.

Fossil-fuel based materials useful to obtain the carbon material 20 include, but are not limited to, coal, lignite, anthracite, bituminous, coal-derived liquid, coal tar, bituminous, pitch, petroleum, and shale. Research grade polymer materials useful to obtain the carbon material 20 include, but are not limited to thermosetting polymers, polyurethanes, polyurea/polyurethane, vulcanized rubber, phenol-formaldehyde, duroplast, polyester resin, melamine resin, epoxy resin, benzoxazines, furan, silicone, thiolyte, thermoplastic polymers, poly(methyl methacrylate) (PMMA), nylon, polylactic acid (polylactide) acrylonitrile butadiene styrene (ABS), polyether sulfone (PES), polyoxymethylene (POM), polyether ether ketone (PEEK), polyetherimide (PEI), polyvinyl chloride (PVC), polypropylene (PP), polystyrene, polycarbonate, polybenzimidazole, phenolic resin, polystyrene, polyvinylidene fluoride, polyacrylonitrile, polyethylene-terephthalate, polymers, such as polyanilinem (PANI), polypyrrole (PPY), polythiophene and thiophene. It is contemplated that the polymer materials include heteroatom rich (e.g. N, S, P, B, O, combination of thereof) industrial and conjugated polymer materials, and polymer materials with templates such as The most frequently used templates such as mesoporous silica SBA-15, Silica xerogel, and KIT-6.

Organic solution materials useful to obtain the carbon material 20 include and carbon-containing organic solution. An organic a waste product material useful to obtain the carbon material 20 includes, but are not limited to food waste, garden waste (including lawn clippings and tree clippings), and animal waste. Biological tissue material useful to obtain the carbon material 20 include, but are not limited to animal-derived materials.

Metal-organic framework (MOF) material useful to obtain the carbon material 20 include any known MOF materials in which metal-to-organic ligand interactions yield porous coordination networks with surface areas surpassing activated carbons and zeolites. Carbon-containing synthetic material useful to obtain the carbon material 20 include any synthetic material that contains any amount of carbon.

In one embodiment of the material 10, the carbon material 20 includes a doped carbon material and an un-doped carbon material. The doped carbon material includes at least one of a nitrogen, phosphorus, sulfur and an oxygen atom, the dopant having an atomic content of about 0.75 weight % to about 75 weight % based on the total weight of the doped carbon material. In one embodiment, the doped carbon material is pyrolyzed polyacrylonitrile, pyrolyzed melamine, or pyrolyzed thiophene and the un-doped carbon is Carbon black, graphite, graphene, reduced graphene oxide, hard carbon, soft carbon, carbon nanosheets, carbon microsheets, carbon beads, pyrolyzed pitch, pyrolized hemp, pyrolyzed plant fiber, activated carbon, undoped aerogel, or undoped hydrogel. In one embodiment, it is contemplated that the carbon material 20 has a layer of doped carbon material and a layer of un-doped carbon material. In another embodiment, it is contemplated that the carbon material 20 includes doped carbon material interspersed in the un-doped carbon material. It is contemplated that any amount or ratio of doped carbon material and un-doped carbon material may be utilized to form the carbon material 20.

The material 10 includes a compound 30 that facilitates improved performance of an electrochemical storage device. In one embodiment, the compound 30 is one or more element from Group 16 of the periodic table, i.e., the chalcogens. Group 16 elements include oxygen (O), sulfur (S), selenium (Se), tellurium (Te) and polonium (Po). In a particular example, the material 10 includes a material 20 that includes selenium (Se) as the compound 30. As shown in FIG. 1, in one embodiment of the material 10, selenium 30 is impregnated in the carbon material 20. In another embodiment, the compound 30 is SeySx, where x and y are any value between 0 and 1, and the sum of x and y is 1, with the SeS are bonded as a crystalline, amorphous or combined crystalline-amorphous compound In another embodiment, the compound 30 is TeySx where x and y are any value between 0 and 1, and the sum of x and y is 1. In another embodiment, the compound 30 is TezSeySx where x, y and z are any value between 0 and 1, and the sum of z, y and x is 1,with the Se, S, Te being present as a multiple phase alloy that is amorphous, crystalline or combined amorphous-crystalline.

It is contemplated that compound 30 can be a combination of any of the following: Se, SeySx, TeySx, and TezSeySx, where x, y and z are any value between 0 and 1, the sum of y and x being 1, and the sum of z, y and x being 1. It is contemplated that if compound 30 is a combination of any of the following: Se, SeySx, TeySx, and TezSeySx, any amount or ratio of Se, SeySx, TeySx, and TezSeySx can be used. In one example, if Se and SeySx are present in the carbon material 20, they are present in a ratio of 1:10 to 10:1. In another example, if compound 30 includes a combination of Se, SeySx, and TeySx, they are present in a ratio of 1:1:1. The aforementioned ratios are given as exemplary embodiments only as it is contemplated that any ratio of are useful when compound 30 is a combination of any of the following: Se, SeySx, TeySx, and TezSeySx.

It is contemplated that any amount of the compound 30 (whether it is one compound or a combination of compounds) can be included in the carbon material 20. In one embodiment, the total amount of compound 30 present is in an amount of 9-90% by weight, based on the total weight of the material 10.

In a particular embodiment, any amount of selenium (Se) can be included in the carbon material 20 to form material 10. In a specific embodiment, the carbon material 20 includes 70% Se by weight, based on the total weight of the carbon material 20. In another embodiment, the carbon material 20 includes up to 95% Se by weight, based on the total weight of the carbon material 20. In another embodiment, the carbon material 20 includes up to 60% Se by weight, based on the total weight of the carbon material 20.

The compound 30 may be impregnated into the carbon material 20 using any sufficient method, including but not limited to co-milling, co-mixing, co-rolling, co-physical depositing, co-casting, co-slurry processing, wet impregnation, co-annealing, chemical vapor deposition, plasma enhanced chemical vapor depiction, atomic layer deposition, physical vapor depiction, evaporation, sputtering, sol-gel processing, electrochemical methods, chemical methods wet and dry, electroless deposition, plating. Ion active and inactive phases may be incorporated into the material 10 simultaneously or in a sequence, per the methods described. An example of simultaneous incorporation is melt infiltrating the active Se phase and an inactive polymer phase into the structure in a single thermal step. An example of sequential incorporation is melt infiltrating the compound 30, e.g., the Se phase, followed by co-milling to introduce the carbon.

Phases may be any material that is Li, Na, K, Al or Mg active, or a combination of one or several active and inactive phases. The morphology of the phases may be thin films or various 2D and 3D geometries, including nanowires, nanotubes, nanospheres, nanoparticulates, nanopowders, microwires, microtubes, microspheres, microparticulates, micropowders.

It is contemplated that making the material 10 includes chemically or physically changing the textural properties of the carbon material 20, by annealing with an inorganic base to form the carbon material 20 of the material 10. Activating of the carbon material 20 defines the tunable pore size distribution of the carbon material. According to an embodiment, the tunable pore size distribution of the carbon material is modulated to be primarily microporous (i.e., have at least 50% by volume of pores having a size of <2 nm). In another embodiment, the tunable pore size distribution of the carbon material is modulated to be primarily mesoporous (i.e., have at least 50% by volume of pores having a size between 2 nm-50 nm). In another embodiment, the tunable pore size distribution of the carbon material is modulated to be about 50% by volume microporous and 50% mesoporous. It is contemplated that the carbon material may have macropore (pore size of >50 nm) regardless of the microporosity and/or mesoporosity of the carbon material. That is, it is contemplated that when the carbon material is primarily microporous, the carbon material may have macropores. Likewise, if the carbon material is primarily mesoporous, the carbon material may have macropores. Additionally, if the carbon material is 50% microporous and 50% mesoporous, the carbon material may also have macropores. The addition of the compound 30 to the carbon material 20 results in the penetration of the compound 30 into the pores or the coating of the surface of the carbon material by the compound thereby bonding with the pores and, in either case, reducing or eliminating open porosity in the electrode material 10.

In one embodiment, the Se is primarily bonded to the nanopores of the carbon present in the carbon material 20. In one embodiment, the initial pore volume is at least 0.25 cm³ g⁻¹ and with a surface area of 250 m² g⁻¹. In one advantageous embodiment, the compound 20 is selenium (Se). However, the compound 20 also may be sulfur (S), metal sulfides, silicon (Si), tin (Sn), antimony (Sb), germanium (Ge), and/or compounds or alloys thereof. The compound 20 may also be titanium oxide (TiO2) and/or LixTiyOz compounds (e.g., Li4Ti5O12 or LTO). Further, the compound 20 may be, for example, LFP (lithium iron phosphate, LiFePO4); NCM (lithium nickel cobalt manganese oxide, LiNiCoMnO2); NCA (lithium nickel cobalt aluminum oxide, LiNiCoAlO2); LMO (lithium manganese oxide, LiMn2O4), LCO (lithium cobalt oxide, LiCoO2); Li2MnO3; vanadates; Mn-oxide based/oxides containing Li and Co and/or Ni and/or Mn and/or Fe, and/or Al, etc.; complex oxides containing Li or Na with a voltage profile suitable for cathode materials; pre-lithiating agents such as stabilized Li power, Li fluorides, Li conversion compounds, Li sulfides, etc. In some embodiments, the compound 20 is one of CoSb, LiCoO2, LiCoPO4, LiFeO2, LiFePO4, Li2FeSiO4, LiMnO2, Li2Mn3NiO8, Li2Mn3NiO8, LiMn2O4, Li2MoO4, LiNi0.8Co0.15Al0.05O2, LiNi0.8Co0.15Al0.05O2, LiNi0.8Co0.2O2, LiNiO2, LiNi0.33Mn0.33Co0.33O2, LiNi0.33Mn0.33Co0.33O2, or Mn0.75Ni0.25CO3.

In one embodiment of material 10, selenium is impregnated into a mesoporous monolithic nanocellulose-derived film to obtain a material 10 referred to as Se-NanoCellulose derived Mesoporous Carbon (Se-NCMC), which has high density and contains no detectable open porosity. In one embodiment, a material comprising Se-NCMC material 50 has a density of 2.37 g cm⁻³. In a another embodiment of the material 10, selecium and sulfur are impregnated into a mesoporous monolithic nanocellulose-derived film to obtain a material 10 referred to as Se—S-NanoCellulose derived Mesoporous Carbon (Se—S-NCMC) having a density of 3 g cm⁻³. In another embodiment, the material comprises Se—S-NCMC having a density of 1.5 g cm⁻³. In another embodiment, the material comprises Se—S-NCMC having a density of 1 g cm⁻³.

In one embodiment the material has an internal Se-carbon phase distribution which is nanostructured, thereby maximizing the charging kinetics and power characteristics. In one embodiment the material has a substantial fraction of closed internal porosity which is undetectable from examining the surface. The substantial fraction of internal porosity ranges from 10 percent to 90 percent of the total volume. The internal pores do not interact with the electrolyte in an electrochemical storage device, but buffer the lithiation and sodiation stresses, providing for fast kinetics and long cycling life. In another embodiment the internal porosity may be filled by a secondary ion active or ion inactive phase, such as but not limited to Si, Sn, ceramic oxides such as LFP, NCA, NMC, LCO, nitrides, sulfides, phosphides. In one embodiment, a material 10 having a nanocellulose carbon material and selenium has a density of 3 g cm⁻³. In another embodiment, a material 10 having a nanocellulose carbon material and selenium has a density of 2 g cm⁻³. Other densities may range from 1 to 10 g cm⁻³. On a per volume basis, a dense electrode is twice as energetic as the same electrode when it is fabricated into a micro- or a nano-powder. Accordingly, an electrode including the material 10 described herein are advantageous in commercial applications, where the surface areas are purposely kept relatively low as to minimize parasitic surface reactions with the electrolyte. Because the material 10 is dense and has a low surface area and remain nanostructured on the inside, the kinetics and cyclability of electrodes including the material 10 are very good.

In one embodiment, the material 10 used as an electrode or additive in an electrochemical storage device is substantially free of pores. The term “substantially free of pores” as used herein means the entire surface of material 10 contains none or only a few open pores detected by microscopy or photography. In one embodiment, the material 10 is monolithic, i.e., a continuous block of material with a defined three-dimensional shape. In one embodiment, the material 10 is free-standing, e.g., can be used on its own as a cathode without traditional cathode material or used on its own as an anode without traditional anode material. It is contemplated that the material 10 can be any combination of substantially pore free, monolithic, and free standing. It is also contemplated that the material 10 is employed as an ancillary phase in an electrode, in parallel with a primary material, such as, graphite.

Since the material 10 as described herein is a free-standing film or other monolithic two-dimensional type of an object such as a wide flake, a flattened sphere, or a shard with anisotropic dimensions, it is contemplated that the material 10 may be assembled into a coin cell without a copper current collector. Since metal collectors are dead weight inside a battery, collector-free electrodes would be beneficial for further optimizing the gravimetric energy of cells while saving cost.

### Electrochemical Storage Devices

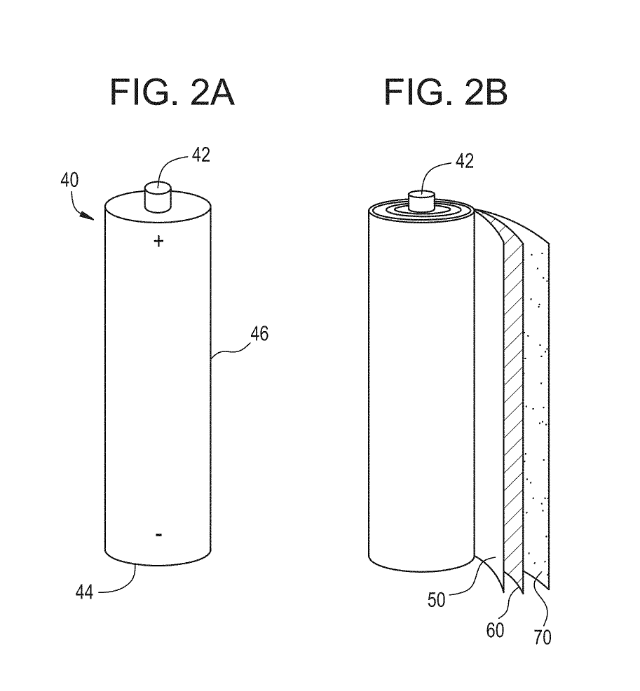

FIGS. 2A and 2B illustrate an electrochemical storage device 40 having at least one electrode. For illustrative purposes, a battery, according to an aspect of the present invention, is shown as the device 40. The device 40 may be, for example, a cylindrical-type 3.7-3.8V secondary (rechargeable) battery in 18650 size. However, one skilled in the art would understand that the invention is not limited to this particular battery types, size or voltage. The features of the present invention may be employed in any number of different types of electrochemical storage devices having any size or voltage, whether standard or custom. The invention is applicable to various electrochemical storage devices, including, but not limited to an electrochemical capacitor, primary or secondary battery, a flow battery, a hybrid ion capacitor or a supercapattery. In one embodiment, the device 40 is a primary battery or a secondary battery. In preferred embodiments, the device 40 is a lithium (Li) ion battery (LIB), lithium metal battery (LMB), sodium (Na) ion battery (SIB) and sodium metal battery (SMB). It is also contemplated that the device 40 may be a magnesium (Mg) ion or potassium (K) ion battery.

The exemplary device 40 is a battery having a first portion with a positive terminal 42 and a second portion with a negative terminal 44. In one embodiment, the device 40 includes at least one electrode. In another embodiment, the device 40 includes a first electrode and a second electrode. As shown in FIG. 2B, in a particular embodiment, the device 40 includes a first electrode 50, which is a cathode, at least one separator 60, and a second electrode 70, which is an anode. In a battery each of the first electrode 50, the separator 60 and the second electrode 70 are wound around one another inside a housing 46. While a secondary rechargeable battery is shown in FIGS. 2A and 2B, the invention is not limited in this regard, as the form of the housing 46 is any form of a housing suitable for an electrochemical storage device, including, but not limited to a form of a D-cell sized battery, a pouch cell, a rectangular automotive starter battery scale cell, a C-cell sized battery, an AA-cell sized battery, an AAA-cell sized battery, a 18650 lithium ion battery, or a 26650 lithium ion battery.

As shown in FIGS. 2A and 2B, the first electrode 50 and the second electrode 70 are connected to the positive 42 and negative 44 terminals, respectively. The first electrode 50 and second electrode 70 may be mixed with a binder and a conductivity additive (e.g., carbon black). In one embodiment, as shown in FIGS. 2A and 2B, the first electrode 50, separator 60, and second electrode 70 are submerged in an electrolyte solution (not shown). As one skilled in the art would understand, when charging a battery, ions (e.g., lithium, sodium, etc.) travel from the cathode to the anode while, during the battery discharge, the ions travel from the anode to the cathode.

In one embodiment of the electrochemical device 40, the material 10 as described above can be incorporated into the device as a first electrode 50, a separator 60, and/or a second electrode 70. By incorporating the material 10 into the electrochemical storage device 40 at least one of: cycling stability, Coulombic efficiency (CE), solid electrolyte interphase growth (SEI), and dendrite growth is improved.

If the material 10 is used as a positive electrode, i.e., first electrode 50, it can be used as a free-standing cathode, or in can be used in parallel with a primary cathode selected from a lithium iron phosphate (LFP) cathode, a nickel cobalt aluminum (NCA) cathode, a nickel manganese cobalt (NMC) cathode, and a lithium cobalt oxide (LCO) cathode. In such an embodiment, the second electrode 70 is a negative electrode (anode) which is an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, or a nitride anode.

If the material 10 is used as a negative electrode, i.e., second electrode 70, it can be used as a free-standing anode, or it can be used in parallel with a primary anode selected from a graphite anode, a hard carbon anode, a tin anode, a Ge anode, and a titania anode. In such an embodiment, the second electrode is a positive electrode (cathode) which is a lithium iron phosphate (LFP) cathode, a nickel cobalt aluminum (NCA) cathode, a nickel manganese cobalt (NMC) cathode, or a lithium cobalt oxide (LCO) cathode.

In another embodiment of the device 40, the device includes the housing 46 and at least one electrode. In this embodiment, it is contemplated that either the first electrode 50 and/or the second electrode 70 is a primary electrode material that includes one or more Group 16 elements. For example, the first electrode 50 is a positive electrode (cathode) that includes a primary cathode material and a compound that is one or more elements from Group 16 of the periodic table, i.e., the chalcogens. Group 16 elements include oxygen (O), sulfur (S), selenium (Se), tellurium (Te) and polonium (Po). In a particular example, the first electrode 50 includes selenium (Se) as the compound. In another embodiment, the first electrode 50 includes SeySx, where x and y are any value between 0 and 1, and the sum of x and y is 1. In another embodiment, the first electrode 50 includes TeySx where x and y are any value between 0 and 1, and the sum of x and y is 1. In another embodiment, the first electrode 50 includes TezSeySx where x, y and z are any value between 0 and 1, and the sum of z, y and x is 1. It is contemplated that the first electrode 50 can includes a combination of any of the following compounds: Se, SeySx, TeySx, and TezSeySx, where x, y and z are any value between 0 and 1, the sum of y and x being 1, and the sum of z, y and x being 1. In such an embodiment, the second electrode 70 is a negative electrode (anode) which is an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, or a nitride anode.

In one embodiment, the first electrode 50 (positive electrode) includes at least one of Se, SeySx, TeySx, and TezSeySx and further includes a carbon material. In another embodiment, the first electrode 50 (positive electrode) includes at least one of Se, SeySx, TeySx, and TezSeySx and further includes a lithium source or a sodium source. Lithium or sodium may be introduced into the electrode by electrochemical lithiation, chemical lithiation, physical mixing, physical incorporation, layering, vapor phase deposition, liquid or solid phase reaction to form LiₓSe_{y}, LiₓS_{y}, LiₓSe_{y}S_{1-y} and similar Na compounds, diffusion of these compounds through the electrolyte to the counter electrode, solution and re-precipitation of these compounds through the electrolyte, evaporation and melting. The LiₓSe_{y}, LiₓS_{y}, LiₓSe_{y}S_{1-y} and similar Na compounds may be directly incorporated into an anode, a cathode, anode and cathode, through direct physical, chemical and electrochemical addition during electrode fabrication and cell assembly. The LiₓSe_{y}, LiₓS_{y}, LiₓSe_{y}S_{1-y} and similar Na compounds may be employed in the electrode to enhance cycling stability, improve Coulombic efficiency, enhance rate capability, enhance energy density and prevent dendrite growth. The LiₓSe_{y}, LiₓS_{y}, LiₓSe_{y}S_{1-y} and similar Na compounds may be incorporated into the electrode by precipitation from the liquid or solid electrolyte, during storage, and during charge-discharge cycling. The LiₓSe_{y}, LiₓS_{y}, LiₓSe_{y}S_{1-y} and similar Na compounds may be incorporated into the electrode by a thermal annealing, low temperature annealing, aging, and electrochemical conditioning. The LiₓSe_{y}, LiₓS_{y}, LiₓSe_{y}S_{1-y} and similar Na compounds may be incorporated into the negative electrode by combining with phases such as Si, Ge, SeGe, Sn, Sb, graphite, hard carbon, soft carbon, graphene, or a combination of such phases and Li and Na metals and alloys. In such an embodiment, the second electrode 70 is a negative electrode (anode) which is an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, or a nitride anode.

In another embodiment of device 40, the first electrode 50 (positive electrode) is a lithium iron phosphate (LFP) cathode, a nickel cobalt aluminum (NCA) cathode, a nickel manganese cobalt (NMC) cathode, or a lithium cobalt oxide (LCO) cathode and the second electrode 70 (negative electrode, anode) is a primary anode material including one or more Group 16 elements. For example, the second electrode 70 is a negative electrode (anode) that includes a compound being one or more elements from Group 16 of the periodic table, i.e., the chalcogens. Group 16 elements include oxygen (O), sulfur (S), selenium (Se), tellurium (Te) and polonium (Po). In a particular example, the first electrode 50 includes selenium (Se) as the compound. In another embodiment, the second electrode 70 includes SeySx, where x and y are any value between 0 and 1, and the sum of x and y is 1. In another embodiment, the first electrode 50 includes TeySx where x and y are any value between 0 and 1, and the sum of x and y is 1. In another embodiment, the first electrode 50 includes TezSeySx where x, y and z are any value between 0 and 1, and the sum of z, y and x is 1. It is contemplated that the second electrode 70 can include a combination of any of the following compounds: Se, SeySx, TeySx, and TezSeySx, where x, y and z are any value between 0 and 1, the sum of y and x being 1, and the sum of z, y and x being 1.

In a particular embodiment of the device 40, the second electrode 70 includes at least one of Se, SeySx, TeySx, and TezSeySx and further includes a lithium source or a sodium source. In another embodiment of the device 40, the second electrode 70 includes at least one of Se, SeySx, TeySx, and TezSeySx, and further includes one or more of a lithium metal, a sodium metal, an amorphous carbon, a hard carbon, a soft carbon, graphite, graphene, activated carbon, and other carbon materials, silicon, germanium, tin, lead, various Li active oxides, nitrides, phosphides, sulfides and selenides, a combination of organic and inorganic active and inactive materials, though not limited thereto. Another example includes storing redox active oxides and nitrides, such as, Fe203, NiO, VxOy, VxPyOx, Co₃0₄, MnxOy, RuxOy, or Fe₃0₄.

In a preferred embodiment of the device 40, the second electrode 70 (negative electrode, anode) including at least one of Se, SeySx, TeySx, and TezSeySx further includes a graphite anode, a hard carbon anode, a tin anode, a Ge anode, or a titania anode.

In another embodiment, the first electrode 50 is a positive electrode having carbon material. In another embodiment, the first electrode 50 is a positive electrode further including a lithium iron phosphate (LFP) cathode, a nickel cobalt aluminum (NCA) cathode, a nickel manganese cobalt (NMC) cathode, or a lithium cobalt oxide (LCO) cathode. In such an embodiment, the device includes a second electrode being a negative electrode including of an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, or a nitride anode

Another aspect of the invention is a device 40 being a battery having a cathode 50 that includes a material 10 having a carbon material 20 including a compound 30 as described above. The battery 40 is either a lithium battery or a sodium battery and has excellent functionality with respect to volumetric capacity and energy density. In a specific example the battery 40 includes a cathode 50 having a material 10 that is monolithic and includes nanocellulose-derived mesoporous carbon film as the carbon material 20 and selenium as the impregnated compound 30, i.e., Se-NCMC, which has no detectable open porosity (i.e., is substantially free of open pores). In another a specific example, the battery 40 includes a cathode 50 having a material 10 that is monolithic and includes nanocellulose-derived mesoporous carbon film as the carbon material 20 and selenium and sulfur as the impregnated compound 30, i.e., Se—S-NCMC, which has no detectable open porosity (i.e., is substantially free of open pores).

The invention will now be illustrated by the following examples. The examples are not intended to limit the scope of the present invention. In conjunction with the general and detailed descriptions above, the examples provide further understanding of the present invention.

### EXAMPLES

### Preparation of Se-NanoCellulose Derived Mesoporous Carbon (Se-NCMC) Material

NanoCellulose derived Mesoporous Carbon film (NCMC) was prepared by a sacrificial-template method as known in the art. Specifically, a slurry of Nanocrystalline Cellulose (NC) at a concentration of 11.5 wt % solids was purchased and used. The NC slurry was firstly diluted to a 4 wt % suspension by adding MQ water and 1 hr. magnetic stirring. In a typical synthesis process, 5 mL NC suspension was taken for one batch of sample. 350 μL Tetraethylorthosilicate (TEOS) was added and the suspension stirred until a homogeneous colloidal solution formed. The solution was dried under ambient condition in a polystyrene Petri dish. The obtained translucent free standing thin films can be easily peeled off from the dish after drying. The thin film was then carbonized at 1000° C. in for 6 hrs. in argon. This yielded a carbon/SiO₂ composite film. The SiO₂ in the composite was then removed by dilute HF etching. After the etching and washing, a free standing NC derived Mesoporous Carbon film (NCMC) was obtained. To prepare Se-NCMC composite materials, Se powder was placed directly on top of the free standing NCMC films, starting with a mass ratio of 3:1 (Se:carbon). The selenium was then melted at 260° C. with the impregnation process maintained for 12 hrs.

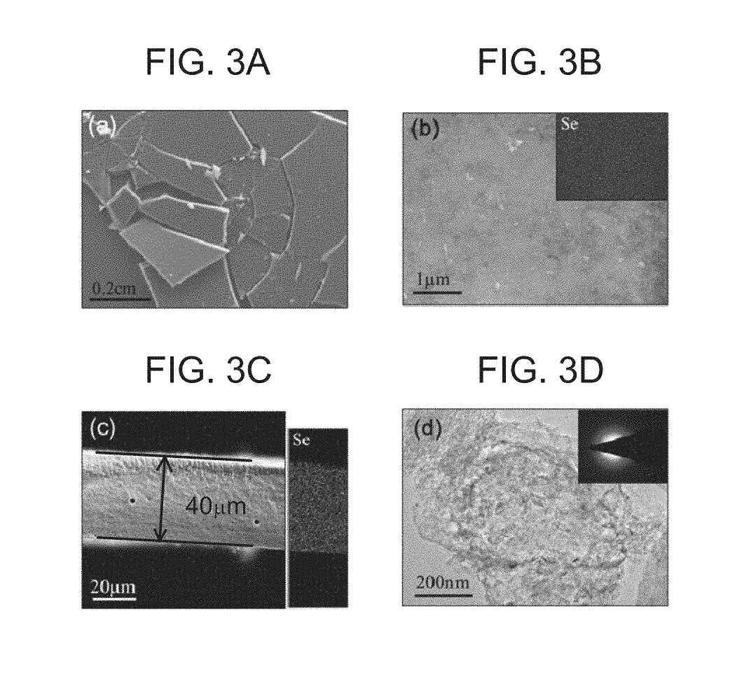

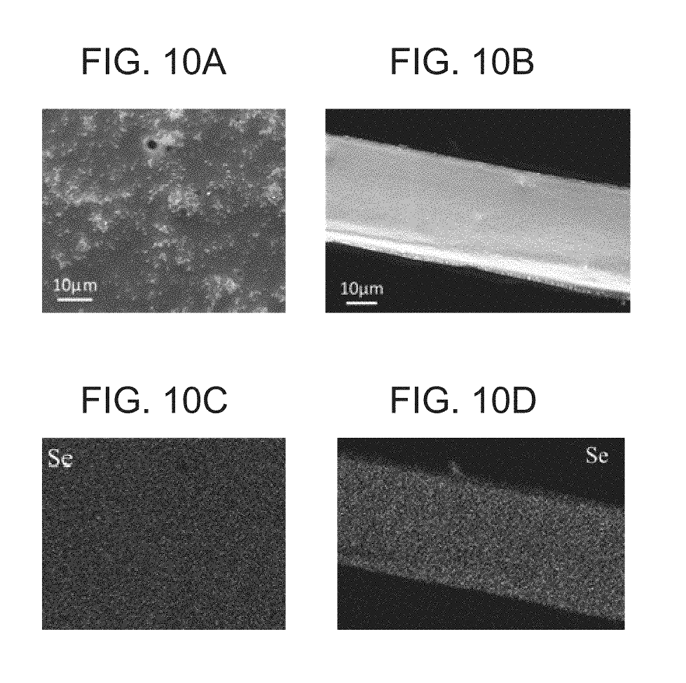

As shown in FIGS. 3A-3D and FIGS. 10A-10D, Se-NCMC does not display any open porosity. FIG. 3A is a low magnification SEM micrograph of the monolithic Se-NCMC films. FIG. 3B is a SEM micrograph of the Se-NCMC surface and the corresponding EDX map of Se. FIG. 3C is a SEM micrograph of the cross-section of NCMC film and the corresponding EDX map of Se. FIG. 3D is a bright field TEM micrograph of Se-NCMC and the associated selected area electron diffraction (SAED) pattern.

FIGS. 10A-10D show SEM and EDX characterization of Se-NCMC that was cycled 300 times in a lithium (Li) cell. FIGS. 10A-10D illustrate that the Se-NCMC is structurally stable, resists pulverization and fracture during cycling. In particular, FIGS. 10A and 10B show a structurally intact electrode with uniform Se distribution. FIG. 10C is a SEM micrograph of the Se-NCMC surface and the corresponding EDX map of Se. FIG. 10D is a SEM micrograph of the cross-section of NCMC film and the corresponding EDX map of Se.

Per the energy dispersive X-ray (EDX) spectroscopy maps of Se shown in FIG. 3B, the Se distribution is uniform throughout the carbon-structure host. A thin Se layer also likely coats the surface of the material. FIG. 3C illustrates that selenium is uniform through the flake thickness, which illustrates full penetration of selenium into the pores throughout, thereby resulting in a material that has no open porosity.

### Determination of Selenium Loading on NCMC

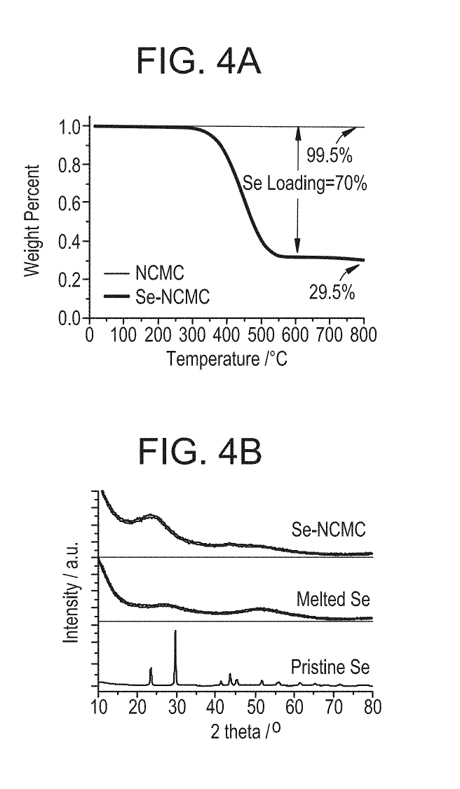

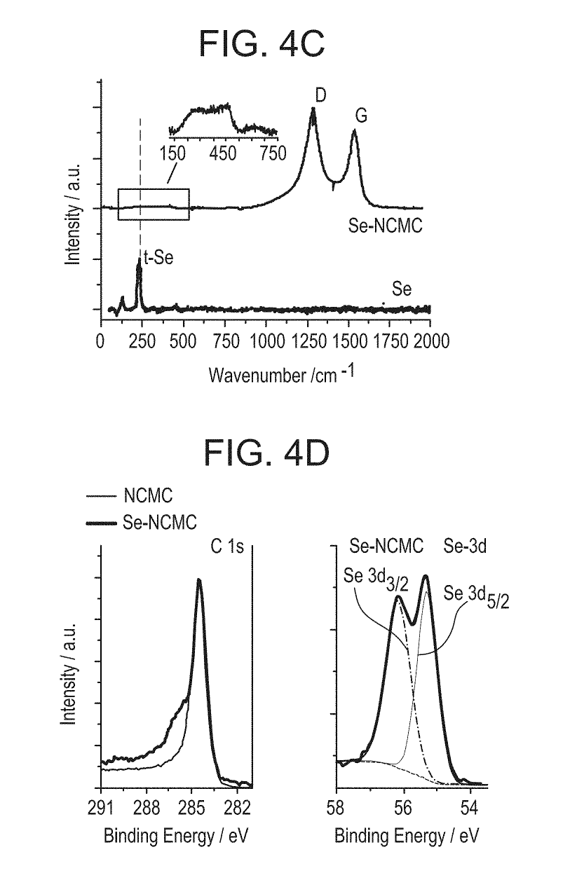

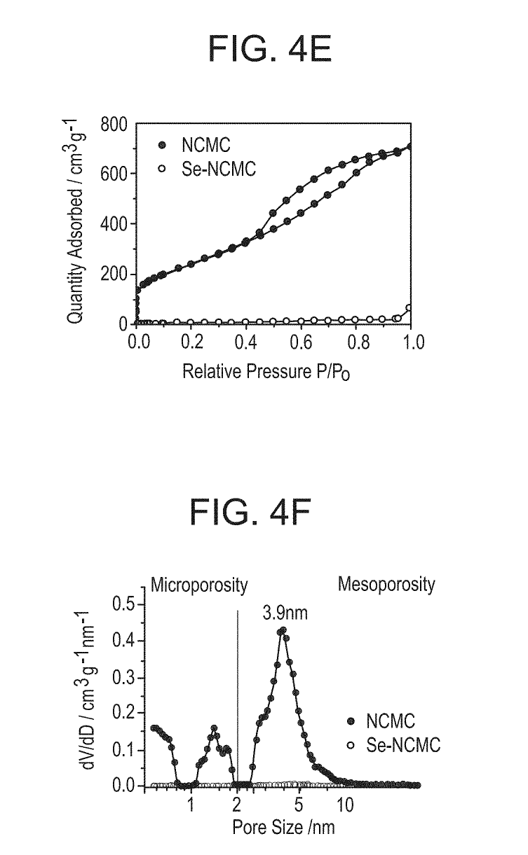

Thermogravimetric analysis (TGA) was used to investigate the selenium to carbon weight ratio in the Se-NCMC composite material, the results being shown on FIG. 4A. All TGA analyses were performed under an argon atmosphere. Up to 800° C., NCMC exhibited negligible weight loss (<0.5%). Conversely the Se in Se-NCMC began evaporation at 300° C., resulting in 70% weight loss by 800° C. Therefore, the total loading of selenium in the Se-NCMC composite material is 70% by weight.

The cross-section image FIG. 3C shows that the Se-NCMC composite material has an average thickness of 40 μm. With a representative weight of 2.85 mg for a 1 cm×1 cm×40 μm sized NCMC host without the Se, its density is 0.71 g cm⁻³. Based on this density and 70 wt. % Se in the final Se-NCMC composite material, the volumetric loading of selenium is 1.66 g cm⁻³. Since selenium impregnation of the carbon-structure host does not appreciably change the dimensions of the material, the Se-NCMC composite density is 2.37 g cm⁻³. This value is used for the volumetric capacity and energy density calculations. For a 1 cm⁻³ composite, there are 0.71 g of carbon and 1.66 g of Se, with the total mass loading summing, i.e. (0.71+1.66) g/1 cm⁻³=2.37 g cm⁻³.

FIG. 4B shows the XRD pattern of the pristine selenium powers, which are of the equilibrium trigonal crystal system P3₁21. For the Se-NCMC composite material pattern, the equilibrium crystalline Se peaks were distinctly absent meaning that the material is fully amorphous.

Raman spectrum was used to further investigate the structure of Se phase in each material. As shown in FIG. 4C, pristine selenium powder exhibited pronounced peaks at 142 and 234 cm⁻¹, which illustrate that selenium exists in the equilibrium trigonal structure. As observed for Se-NCMC composite materials, these characteristic peaks disappear, leaving a very broad hump at the 250-500 cm⁻¹ range, which is associated with the low order Se species such as the amorphous allotrope, meaning that the material is fully amorphous. The high resolution X-ray photoelectron spectroscopy (XPS) of C 1s and Se 3d of the specimens are shown in FIG. 4D, which illustrates that Se-NCMC composite material exhibits more asymmetry, meaning that in addition to impregnating into the pores, the Se forms chemical bonds with the carbon host.

FIG. 4E shows the nitrogen adsorption-desorption isotherms of the Se-NCMC composite material and NCMC material samples. FIG. 4F shows their resultant pore size distributions, obtained by density functional theory (DFT). The NCMC material exhibited typical characteristics of ordered mesoporous materials. According to the pore size distributions in FIG. 4F, majority of the porosity in NCMC material is concentrated in the mesoporous region with average pore size of 3.9 nm. The narrow distribution of mesopores is a feature of the sacrificial templating method and should allow for improved Se penetration into the carbon structure host (i.e., the NCMC material) as compared to systems with wide pore size distribution extending into the micropore range. The volume of mesoporosity is 0.84 cm³g⁻¹, which takes up 88.4% of the total pore volume (0.95 cm³g⁻¹). The Se loading fills the majority of the pores, giving the Se-NCMC a surface area of 27 m²g⁻¹ and a pore volume of 0.098 cm³g⁻¹.

### Example 1

### Electrochemical Performance of Se-NCMC as a Cathode

The electrochemical functionality of Se-NCMC material as a cathode was investigated, employing lithium and sodium metal as anodes. Depending on whether the target application is lithium/sodium ion batteries (LIBs, NIBs) or lithium/sodium metal batteries (LMBs, NMBs), this configuration may be considered as “half-cell” or as “full cell”. An organic carbonate (i.e. ethylene carbonate (EC), dimethyl carbonate (DMC)) based electrolyte is employed without any additives. For the lithium cells, an electrolyte of 1M LiPF₆ in 1:1 (volume ratio) ethylene carbonate (EC):dimethyl carbonate (DMC) was used. For the sodium cells, NaClO₄ was used as the salt. Lithium and sodium foils were used as counter electrodes.

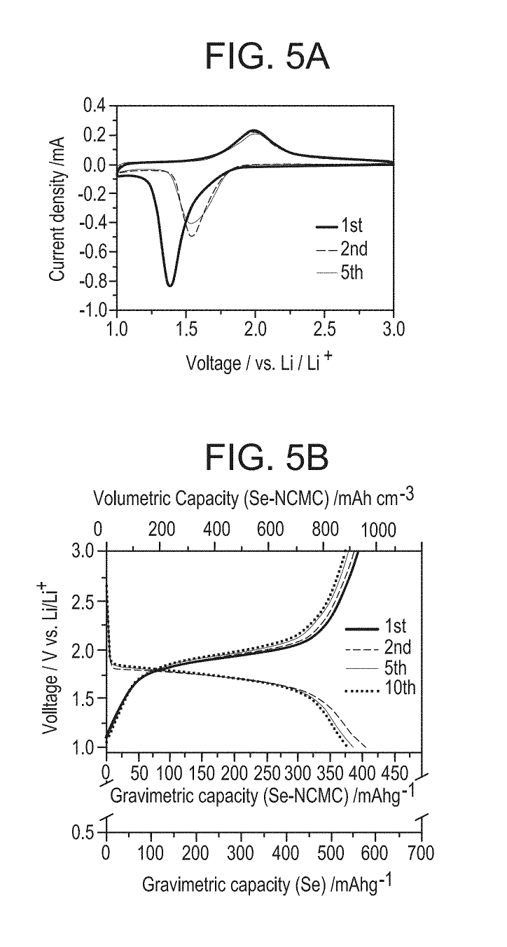

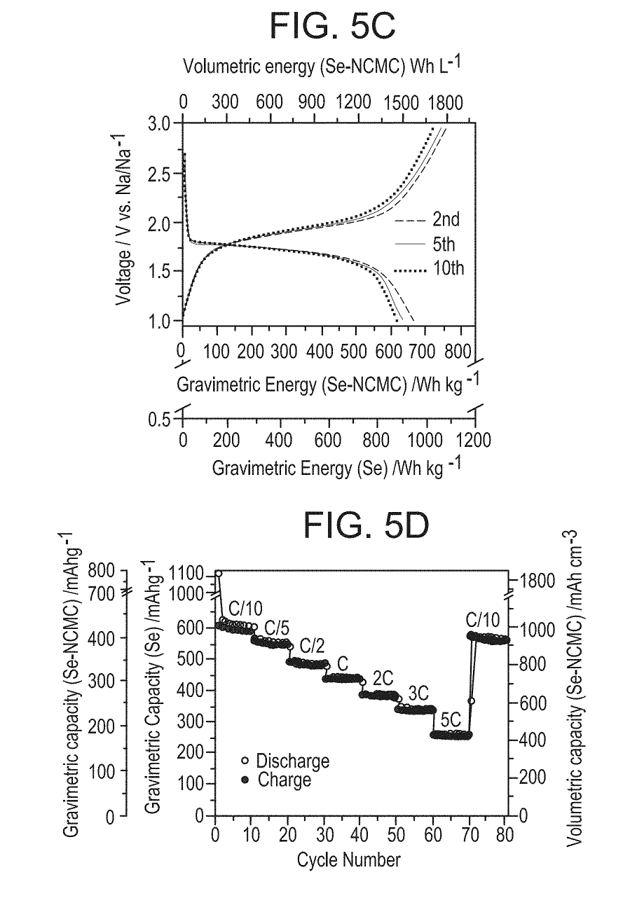

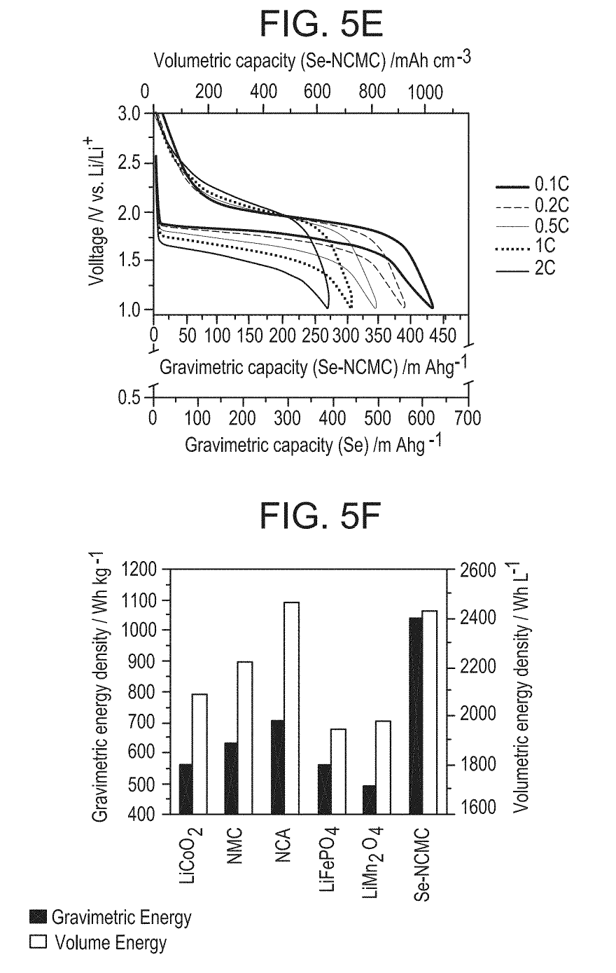

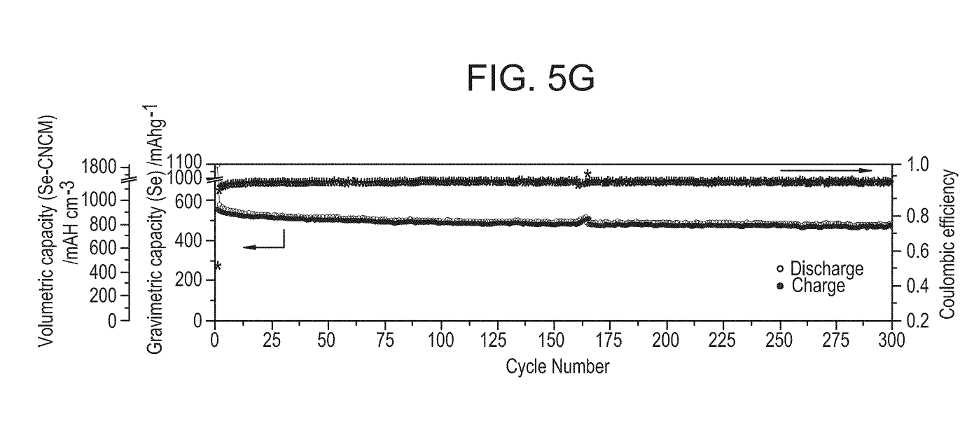

The electrochemical behavior in the lithium system is displayed in FIGS. 5A-5G. Electrochemical tests were carried out using CR-2025 coin cells. FIG. 5(a) shows the cyclic voltammograms (CV) curve of the Se-NCMC against lithium between 1-3V at scan rate of 0.1 mVs⁻¹. Selenium undergoes a direct reaction of Se to Li₂Se, without the formation of intermediate phases. The CVs indicate minimal side reactions between selenium and the carbonyl groups of the carbonate molecules in the electrolyte. The increased cathodic voltage indicates the Seₓ chain contains larger number of Se atoms. From the second cycle, the Seₓ chain length became stable and the repeated lithiation/delithiation process is highly reversible. It may be observed that the cycling is highly stable, which indicates that some Se species have diffused through the electrolyte to the metal anode and stabilized its structure against dendrites.

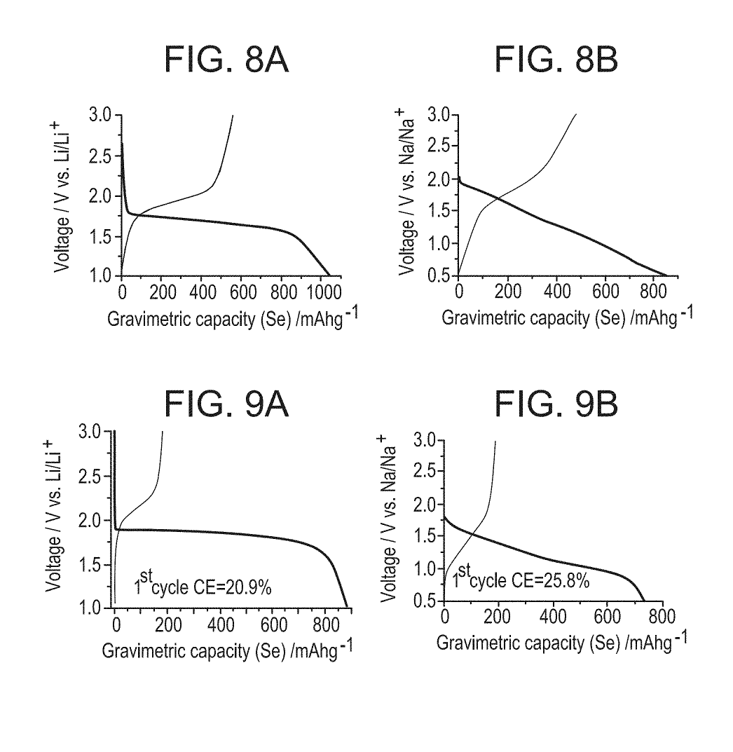

Each of FIG. 4B and FIG. 9A displays the galvanostatic discharge/charge profile of Se-NCMC and of a baseline amorphous Se vs. Li. Tests were done at 0.2 C, where 1 C equals to 675 mAg⁻¹ based on the mass of selenium. For Se-NCMC, the voltages of the plateau agree with the peak positions in the CV curves. The electrode delivered initial discharge capacity of 1042 mAhg⁻¹ and 1^{st} cycle Coulombic efficiency (CE) of 53% (FIG. 8A). For the Se-carbon systems the cycle CE loss is not directly correlated with the surface area. A large surface area electrode on the order of >1000 m² g⁻¹, would yield substantial current due to oxidative electrolyte decomposition (CEI) at voltages >4.2 V Li/Li⁺. The surface area in Se-NCMC is 27 m²g⁻¹ and the maximum voltage is 3V. With Se-NCMC the carbonate-based electrolyte is expected to be anodically stable. The excellent cycling stability demonstrated by the galvanostatic results further illustrates the beneficial effect of Se and Se—Li (SeₓLi_{y}) compounds in promoting a stable anode solid electrolyte interphase (SEI) structure and eliminating dendrites. Cycling stability is a direct indicator of this effect since an unstable SEI and dendrite growth leads to fast capacity decay. The electrodes closed (internal) porosity is also important since it buffers the stresses associated with forming various lithium-selenium compounds, such as Li₂Se.

CE loss mechanisms in Se-NCMC are different from conventional high surface area carbon-based anode materials where solid-electrolyte interphase (SEI) formation may be the dominant loss below approximately 1 V vs. Li/Li⁺ or Na/Na⁺. Even in such systems, bulk Li/Na trapping may be significant throughout the voltage range. To further illustrate the point that early CE loss is due to bulk events in Se, we melt synthesized pure Se powders with an amorphous structure and an electrode mass loading of 4-5 mg cm⁻². The results are provided in Figure S2a. As may be observed, the cycle 1 CE in the film is 20.9%, which significantly lower than for Se-NCMC. This illustrates the need for a stable carbon material such as described herein.

As shown in FIG. 5B, the cathode delivered reversible capacity of 578 mAhg⁻¹ after the first cycle, which is 405 mAhg⁻¹ normalized by the total mass of the composite. As shown in FIG. 5D, at a lower rate of 0.1 C a maximum 620 mAhg⁻¹ capacity was obtained on basis of selenium. This is 434 mAhg⁻¹ on basis of the Se-NCMC composite material. Table S1 compares the physical properties and electrochemical performance of Se-NCMC material as cathode versus known Li—Se-carbon systems.

TABLE S1
A comparison between Se-NCMC and the state-of-the-art selenium based cathodes
from the published literature, tested vs. Li/Li⁺.

| | | | | | | Volumentric | Areal | | |
|---|---|---|---|---|---|---|---|---|---|
| | | | | Density of | Areal | capacity | Capacity | | |
| | | | | the | loading | (mAh cm⁻³ | (mAh cm⁻³ | | |
| | Material | | Se | composite | of Se | based on | based on | Capacity | |
| Material | size^{a} | | wt % | (g cm⁻³) | (mg cm⁻³) | composite) | selenium) | retention | Ref. |
| Se-NCMC | 40 | μm | 70% | 2.37 | 6.64 | 1028 | 4.12 | 82% upon | This |
| | | | | | | | | 300 cycles | week |
| Se/ [symbol] | ~250 | nm | 50.2% | 2.02^{c} | 2.0 | 684 | 1.35 | 75% upon | [1] |
| microporous | | | | | | | | 300 cycles | |
| carbon | | | | | | | | | |
| Se/microporous | ~200 | nm | 50% | 2.06^{c} | 2.0 | 690 | 1.34 | 85% upon 50 | [2] |
| carbon | | | | | | | | cycles | |
| particles | | | | | | | | | |
| Se/microporous | ~100 | nm | 70.5% | 1.70^{c} | 2.0 | 779 | 1.30 | 77% upon | [3] |
| carbon | | | | | | | | 250 cycles | |
| spheres | | | | | | | | | |
| Se [symbol] CNx | 70-90 | nm | 62.5% | 1.20 | 3.0 | 487^{b} | 1.95 | 80% upon | [4] |
| nanofibres | | | | | | | | 400 cycles | |
| Se [symbol] microporous | 500 | nm | 70% | 1.60 | 3.0 | 673 | 2.80 | Not reported | [5] |
| carbon | | | | | | | | | |
| particles | | | | | | | | | |
| SeC | ~50 | nm | 62% | 0.39 | 1.2 | 195^{b} | 0.79 | 86% upon | [6] |
| nanofibres | | | | | | | | 100 cycles | |
| Se/microporous | ~5 | μm | 30% | Not | Not | Not reported | Not reported | 100% upon | [15] |
| carbon | | | | reported | reported | | | 1K cycles | |
| spheres | | | | | | | | | |
| Se/porous | ~250 | nm | 52.3% | Not | 0.8 | Not reported | 0.56 | 95% upon | [7] |
| carbon | | | | reported | | | | 980 cycles | |
| nanofibres | | | | | | | | | |
| Se/porous | ~10 | nm | 67% | Not | 1.5 | Not reported | 0.98 | 98% upon | [8] |
| carbon | | | | reported | | | | 150 cycles | |
| particles | | | | | | | | | |
| Se/porous | 1-2 | μm | 54% | Not | 1.2 | Not reported | 0.72 | 77% upon | [9] |
| carbon | | | | reported | | | | 250 cycles | |
| particles | | | | | | | | | |
| 3DG- | ~10 | nm | 51% | Not | 1.6 | Not reported | 0.96 | 83% upon | [10] |
| CNT [symbol] Se | | | | reported | | | | 150 cycles | |
| Se/microporous | 170 | nm | 50% | Not | 1.2 | Not reported | 0.72 | 90% upon | [11] |
| carbon | | | | reported | | | | 100 cycles | |
| nanofibres | | | | | | | | | |

^{a}The values listed indicated the smallest dimension in the composite material.
^{b}The values were calculated based on the thickness of the electrode, areal loading of selenium and the weight percentage of selenium in the composite reported in the relevant literature.
^{c}The density values were obtained buy pressing the material pellets at 10 Mpa. [symbol]
indicates data missing or illegible when filed

The density of the Se-NCMC composite (2.37 g cm⁻³) is the by far the highest, even as compared to heavily pressed electrodes. Combining with a high selenium mass loading, a typical 40 μm thin film electrode gives an areal selenium loading as high as 6.64 mg cm⁻² and relevant areal capacity of 4.12 mAh cm⁻², both of which doubles the counterpart values of the nano-/micro-sized Se/carbon composites (Table S1). Based on the composite density, the volumetric capacity of Se-NCMC composite is as high as 1028 mAh cm⁻³, which is also the most favorable.

As shown in FIG. 5C, the energy density for the first discharge is 660 Wh kg⁻¹ normalized by the total mass of the composite, which is 1564 Wh L⁻¹ in term of volumetric energy density. The energy efficiency between charge and discharge is around 87%, indicating a relatively small voltage hysteresis. FIG. 5D shows the capacities of Se-NCMC composite material as cathode at various current densities ranging from 0.1 C-5 C (i.e. 0.68 Ag⁻¹-3.4 Ag⁻¹). Reversible capacities as normalized by the mass of selenium (mass of composite) were 385(270), 340(238), and 257(180) mAhg⁻¹, obtained at 2 C, 3 C and 5 C. The corresponding volumetric capacities are 639, 564 and 426 mAh cm⁻³ normalized by the composite volume. With increasing C-rate, the pronounced plateaus still exist but with increasing polarization between the charge and discharge, as shown in FIG. 5E. At 0.1 C, the highest capacity obtained is 620(423) mAhg⁻¹, which corresponds to an energy density of 1041 Wh kg⁻¹ and 2467 Wh L⁻¹, normalized by the mass of selenium and total volume of the composite, respectively. These values rival or are superior to the currently dominant lithium ion battery cathodes, as shown in FIG. 5(f).

The Se-NCMC material as cathode was tested for extended cycling lifetime, at a conventional rate of 0.2 C. As shown in FIG. 5G, Se-NCMC material as cathode exhibits excellent cycling stability versus lithium. The excellent cyclability is believed to be due to the “extra” internal space (i.e. closed porosity) in the carbon matrix to buffer the lithiation/sodiation-induced expansion. It is also due to the role of Se in stabilizing the Li metal-electrolyte interface against dendrites and run away SEI growth.

### Example 2

### Electrochemical Functionality of Se-NCMC as a Sodium Metal Cathode

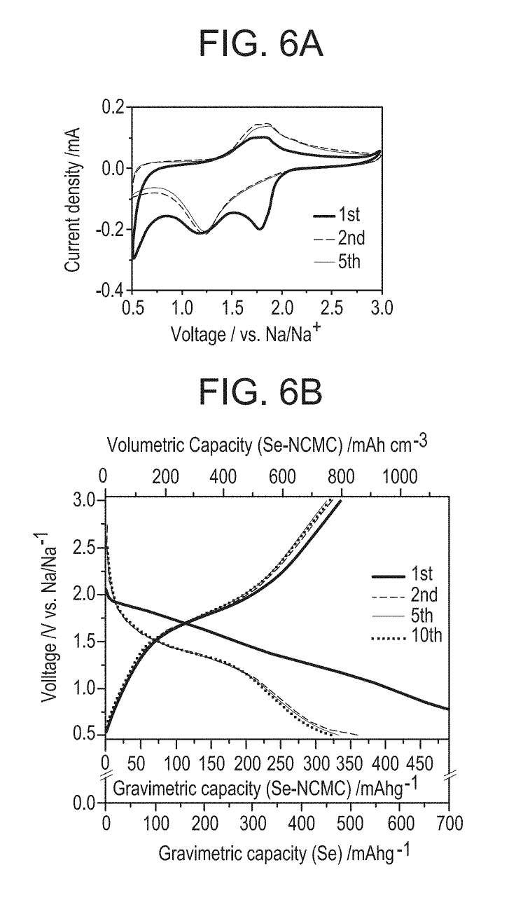

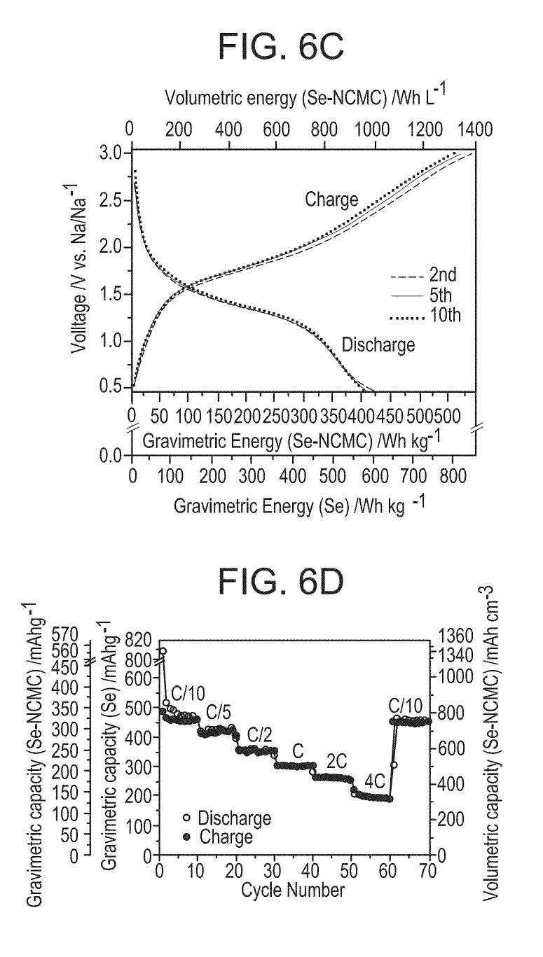

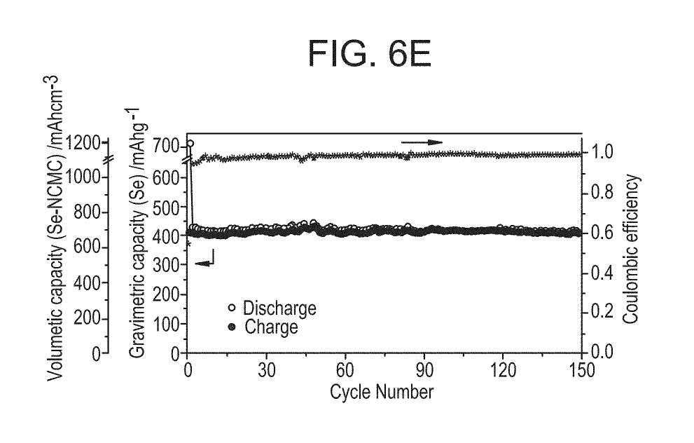

Se-NCMC material was employed as a cathode. A standard organic carbonate-based (EC/DMC) electrolyte with NaClO₄ salt, without any additives was employed. Sodium metal was employed as the anode. FIG. 6A shows the CV curve of the Se-NCMC against sodium, tested between 0.5-3V at 0.1 mVs⁻¹. Compared to the Li—Se system, the cathodic/anode peaks for the Na—Se are much broader. As shown in FIG. 6B, the galvanostatic discharge/charge profiles for Na—Se are also more sloped in shape with less pronounced plateaus. For the Na—Se system, the observed broad redox peak and sloped voltage profile reveal that the reaction is more complex than just a direct transformation between Se and Na₂Se.

In FIG. 6B, the first reversible capacity obtained is 511 mAh g⁻¹ corresponding to 848 mAh cm⁻³. These values are lower than the counterpart values obtained in the lithium system, which indicated the lower utilization of selenium in the sodium system. Lower utilization for Na vs. Li was also observed for other selenium-based cathodes. As shown in FIG. 8B, the 1^{st} cycle Coulombic efficiency of Se-NCMC vs. Na is 58%. According to FIG. 9B, the baseline amorphous selenium film exhibits a lower CE (25.8%). Per FIG. 6C, the discharge process exhibits gravimetric energy of over 400 Wh kg⁻¹ and volumetric energy of over 900 Wh L⁻¹. The energy efficiency is around 72%, which is lower than that in Li—Se system. This is due to a larger charge-discharge voltage hysteresis with a Na anode as compared to with a Li anode.

FIG. 6D shows the capacity of Se-NCMC cathode against sodium, at 0.1 C-4 C (0.068 Ag⁻¹-2.7 Ag⁻¹). Reversible capacities by active mass(electrode mass) were 301(210), 265(186), 198(139) mAhg⁻¹, obtained at 1 C-4 C respectively. The corresponding volumetric capacities are 500, 441 and 328 mAh cm⁻³. This performance is comparable to the Li system in terms of capacity retention with increasing rate. The cyclability of Se-NCMC cathode in Na cell was tested at the same current as with Li, i.e. 0.2 C (135 mAg⁻¹). As shown in FIG. 6E, the Se-NCMC material was overall quite stable during cycling.

Table S2 compares the physical properties and electrochemical performance of Se-NCMC material as cathode versus known Na—Se-carbon systems.

TABLE S2
A comparison between Se-NCMC and the state-of-the-art selenium based cathodes
from the published literature, tested vs. Na/Na⁺.

| | | | | | | Volumentric | Areal | | |
|---|---|---|---|---|---|---|---|---|---|
| | | | | Density | Areal | capacity (mAh | Capacity | | |
| | | | | of the | loading | cm⁻³ based | (mAh cm⁻³ | | |
| | Material | | Se | composite | of Se (mg | on | based on | Capacity | |
| Material | size^{a} | | wt % | (g cm⁻³) | cm⁻³) | composite) | selenium) | retention | Ref. |
| Se-NCMC | 40 | μm | 70% | 2.37 | 6.64 | 848 | 3.39 | 98% upon | This |
| | | | | | | | | 150 cycles | week |
| Se/ [symbol] | ~250 | nm | 50.2% | 2.02^{b} | 2.0 | 659 | 1.32 | 95% upon | [1] |
| microporous | | | | | | | | 100 cycles | |
| carbon | | | | | | | | | |
| Se/microporous | ~5 | μm | 30% | Not | Not | Not reported | Not reported | 95% upon | [13] |
| carbon | | | | reported | reported | | | 150 cycles | |
| spheres | | | | | | | | | |
| Se/porous | ~250 | nm | 40% | Not | Not | Not reported | Not reported | 84% upon | [16] |
| carbon | | | | reported | reported | | | 150 cycles | |
| nanofibres | | | | | | | | | |
| Se/porous | ~250 | nm | 35% | Not | Not | Not reported | Not reported | 98% upon 80 | [14] |
| carbon | | | | reported | reported | | | cycles | |
| nanofibres | | | | | | | | | |
| Se/porous | ~250 | nm | 52.3% | Not | 0.8 | Not reported | 0.48 | 87% upon 80 | [7] |
| carbon | | | | reported | | | | cycles | |
| nanofibres | | | | | | | | | |
| Se/porous | 1-2 | μm | 54% | Not | 1.2 | Not reported | 0.72 | 50% upon | [9] |
| carbon | | | | reported | | | | 50 cycles | |
| particles | | | | | | | | | |
| Se/hallow | ~50 | nm | 52% | Not | 1.0 | Not reported | 0.4 | 95% upon | [0] |
| carbon | | | | reported | | | | 50 cycles | |
| spheres | | | | | | | | | |

^{a}The values listed indicated the smallest dimesion in the composite material.
^{b}The density values were obtained by pressing the material pellets at 10 Mpa. [symbol]
indicates data missing or illegible when filed

### Example 3

### Electrochemical Performance of Se-NCMC as a Cathode

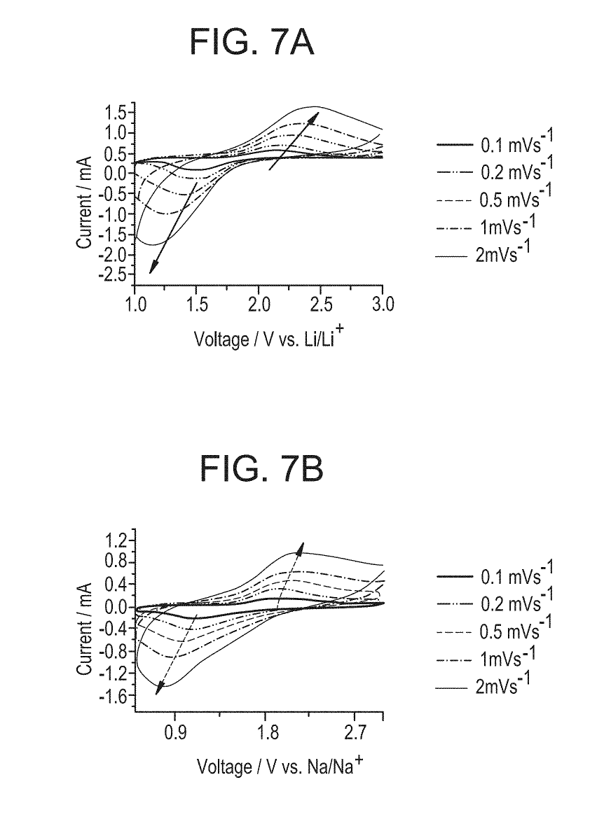

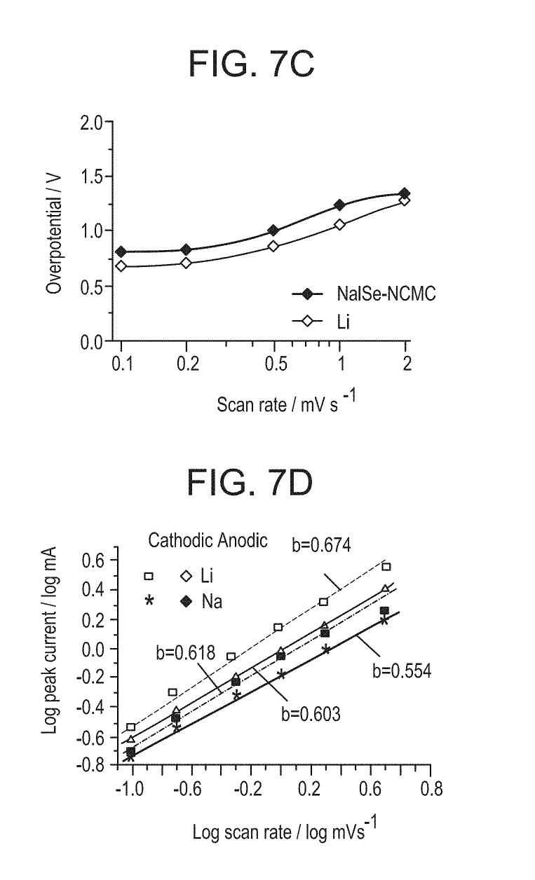

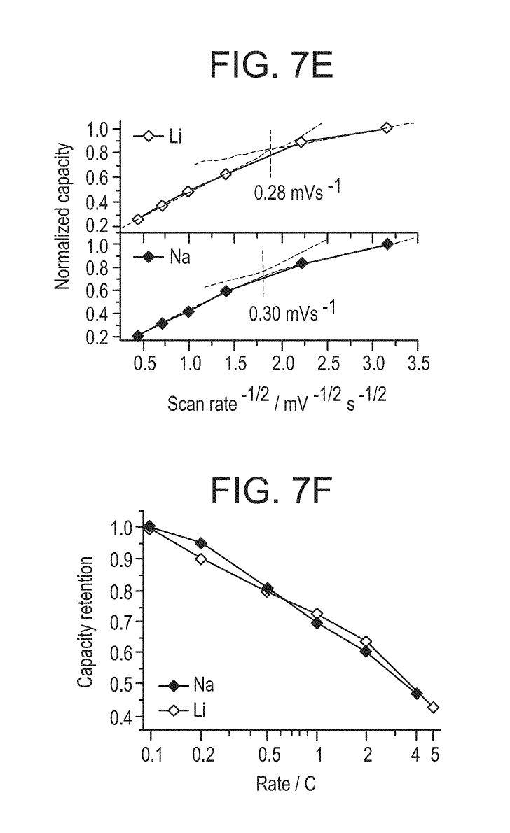

To further elaborate the electrochemical kinetics of Se-NCMC with lithium and sodium, we investigated its current response behavior at scan rates of 0.1-5 mVs⁻¹. These results are shown in FIGS. 7A and 7B, for Li and Na systems, respectively. With increasing scan rate (v), the redox peaks exhibited increasing peak currents (i) as well as voltage shift ΔV, i.e. the reaction overpotential. FIG. 7C plots the reaction overpotential values at different scan rates. The lithium system gives a consistently lower (˜0.12V) overpotential as compared to sodium, except at the highest scan rate tested where the two seem to converge.

A b-value of 0.5 is a straightforward outcome of Fick's law and signals a diffusion-limited process. A b-value of 1 is a standard expression for any activation (i.e. interface) polarization reaction. For bulk reacting systems such as Se, diffusional limitations are generally taken to mean in the solid-state rather than in the electrolyte. Conversely b-value of 1 means that it is an interface-controlled process, the interface potentially being solid-liquid or solid-solid. As shown in FIG. 7C, the b values of both cathodic and anodic processes are analogous for Li versus Na. This indicates a comparable onset of diffusional limitations in both systems, an observation that contradicts the common belief that Na diffusion is always slower than Li in the solid-state.

The relation between the normalization capacity during the CV tests and the v^{-1/2} values also reflect the kinetics of the system under different charge/discharge rates. The results are shown in FIG. 7E. The normalized capacities are calculated according to C=iΔt/mΔE, where C is capacity, Δt and ΔE are the time and voltage change around the peak, and m is the mass of electrodes. It is observed that at approximately the same scan rate (30 mV s⁻¹) the sodiation and lithiation reactions become diffusion limited, agreeing with FIG. 7D. FIG. 7F further highlights this comparison, giving the fraction capacity retention as a function of current density, for Se-NCMC vs. Li and Na metal. The above analysis supports the conclusion that despite the likely difference in the reaction paths, and the measured difference in the reversible capacity and charge/discharge overpotentials, the overall sodiation and lithiation kinetics are similar.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A material used as an electrode or an additive in an electrochemical storage device, the material comprising:
a carbon material; and
a compound selected from the group consisting of Se, SeySx, TeySx, TezSeySx and combinations thereof, where x, y and z are any value between 0 and 1, the sum of y and x being 1, and the sum of z, y and x being 1, the compound impregnated in the carbon material.

2. The material according to claim 1, wherein the compound is present in an amount of 9-90% by weight, based on the total weight of the material.

3. The material according to claim 1, wherein the electrochemical storage device is selected from the group consisting of an ion battery and a metal battery.

4. The material according to claim 3, wherein a charge transfer ion in the electrochemical storage device is selected from the group consisting of lithium ion, calcium ion, sodium ion, potassium ion, hydrogen ion, magnesium ion, ClO4—, PF6—, and a combination thereof.

5. The material according to claim 1, wherein the material is substantially free of open pores.

6. The material according to claim 1, wherein the material is monolithic.

7. The material according to claim 1, wherein the material is free-standing.

8. The material according to claim 1, wherein the carbon material comprises at least one of a plant-based material, a fossil-fuel based material, a research-grade polymer material, an organic solution material, an organic waste product material, a biological tissue material, a metal-organic framework material, and a carbon-containing synthetic material.

9. The material according to claim 8, wherein the plant-based material is selected from the group consisting of hemp-based material, cannabis-based material, wood-based material, ramie-based material, jute-based material, flax-based material, kenaf-based material, and combinations thereof.

10. The material according to claim 1, wherein:
the carbon material comprises at least one of a doped carbon material and an un-doped carbon material,
wherein the doped carbon material comprises at least one of a nitrogen, phosphorus, sulfur and an oxygen atom, the dopant having an atomic content of about 0.75 weight % to about 75 weight % based on the total weight of the doped carbon material.

11. A method to improve performance of an electrochemical storage device, the method comprising:
incorporating a material according to claim 1 into the electrochemical storage device, wherein the material is incorporated into at least one of: an electrode, a separator and an electrolyte,
thereby improving at least one of: cycling stability, Coulombic efficiency (CE), solid electrolyte interphase growth (SEI), and dendrite growth.

12. An electrochemical storage device comprising:
a housing; and
at least one electrode comprising a compound selected from the group consisting of Se, SeySx, TeySx, TezSeySx and combinations thereof, where x, y and z are any value between 0 and 1, the sum of y and x being 1, and the sum of z, y and x being 1.

13. The electrochemical storage device according to claim 12, wherein the at least one electrode is a negative electrode, the negative electrode further comprising a lithium source or a sodium source.

14. The electrochemical storage device according to claim 12, wherein the at least one electrode is a negative electrode, the negative electrode further comprising a graphite anode, a hard carbon anode, a tin anode, a Ge anode, or a titania anode.

15. The electrochemical storage device according to claim 12, wherein the at least one electrode is a positive electrode, the positive electrode further comprising a carbon material.

16. The electrochemical storage device according to claim 12, wherein the at least one electrode is a positive electrode, the positive electrode further comprising a lithium iron phosphate (LFP) cathode, a nickel cobalt aluminum (NCA) cathode, a nickel manganese cobalt (NMC) cathode, or a lithium cobalt oxide (LCO) cathode.

17. The electrochemical storage device according to claim 16, further comprising a second electrode, the second electrode being an negative electrode selected from the group consisting of an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, and a nitride anode.

18. The electrochemical storage device according to claim 12, further comprising at least one of a carbonate containing electrolyte and polymer separator.

19. The electrochemical storage device according to claim 12, wherein the housing comprises a form of a D-cell sized battery, a pouch cell, a rectangular automotive starter battery scale cell, a C-cell sized battery, an AA-cell sized battery, an AAA-cell sized battery, a 18650 lithium ion battery, or a 26650 lithium ion battery.

20. The electrochemical storage device of claim 12, wherein the at least one electrode is a cathode, and the electrochemical storage device further comprises a second electrode, the second electrode is an anode selected from the group consisting of an oxide-based anode, a lithiated tin anode, a lithium metal anode, a sulfur-based anode, a selenium anode, a graphite anode, an activated carbon anode, a graphene anode, a silicon anode, a tin anode, an alloy anode, an oxide anode, a sulfide anode, and a nitride anode.

21. The electrochemical storage device of claim 12, being an electrochemical capacitor, primary or secondary battery, a flow battery, a hybrid ion capacitor or a supercapattery.

22. A battery comprising:
an anode;
a separator;
a cathode, the cathode comprising: a carbon material and at least one compound selected from the group consisting of Se, SeySx, TeySx, TezSeySx, and combinations thereof, where x, y and z are any value between 0 and 1, the sum of y and x being 1, and the sum of z, y and x being 1, wherein the at least one compound is impregnated into the carbon-material; and
an electrolyte.
